(19) United States
(12) Patent Application Publication
(10) Pub. No.: US 2024/0200666 A1
(43) Pub. Date: Jun. 20, 2024

(54) SYSTEMS, ASSEMBLIES, APPARATUSES, AND METHODS PROVIDING ENHANCED ENGAGEMENT BETWEEN VALVE BODIES AND VALVE SEALS

(71) Applicant: Vulcan Industrial Holdings, LLC, Houston, TX (US)

(72) Inventors: Chris Leake, Houston, TX (US); Tanner Ford, Houston, TX (US); Josh Dearman, Houston, TX (US)

(21) Appl. No.: 18/539,014

(22) Filed: Dec. 13, 2023

Related U.S. Application Data
(60) Provisional application No. 63/387,825, filed on Dec. 16, 2022.

(51) Int. Cl. F16K 1/46; F16K 1/36; F16K 1/42

(52) U.S. Cl. CPC F16K 1/46; F16K 1/36; F16K 1/42

(57) ABSTRACT

Systems, assemblies, apparatuses, and methods herein may provide a relatively enhanced engagement between valve components, such as valve bodies and valve seals. A valve member may include a valve body having a valve head and a neck portion connected to the valve head and having a radial dimension less than a radial dimension of the valve head. The valve body may include a seal engaging surface at least partially defining one or more recesses. The valve member further may include a valve seal connected to the valve body around the neck portion and adjacent the seal engaging surface. The valve seal may include a body engaging surface positioned against the seal engaging surface, forming an engagement that may resist one or more of outward radial migration, axial displacement, or rotational displacement of the valve seal relative to the valve body during operation of a pump including the valve member.

### CROSS REFERENCE TO RELATED APPLICATIONS

This application claims priority to, and the benefit of U.S. Provisional Application No. 63/387,825, filed Dec. 16, 2022, titled “SYSTEMS, ASSEMBLIES, APPARATUSES, AND METHODS PROVIDING ENHANCED ENGAGEMENT BETWEEN VALVE BODIES AND VALVE SEALS,” the disclosure of which is incorporated herein by reference in its entirety.

### TECHNICAL FIELD

The present disclosure relates to systems, assemblies, apparatuses, and methods providing enhanced engagement between valve bodies and valve seals and, more particularly, to systems, assemblies, apparatuses, and methods providing enhanced engagement between valve bodies and valve seals for use in high-pressure pumps.

### BACKGROUND

Pumps often include valves to control the flow of fluid into, from, and through a pump chamber of the pump. For example, a reciprocating plunger pump may include a first one-way valve or check valve to allow fluid to be drawn into the pump and a second one-way valve or check valve to permit the discharge of the fluid drawn into the pump while the first valve is closed. For example, the first valve may open to allow fluid to be drawn into the pump while the second valve is closed, and thereafter the first valve may close while the second valve is open while a plunger in the pump increases the pressure of the fluid and forces the fluid through the second valve to pump the fluid.

An example of a high-pressure pump may be used, for example, to pump fracturing fluid at high pressures and high flow rates during a hydraulic fracturing operation. For example, a hydraulic fracturing operation involves pumping a fracturing fluid at high flow rates and high pressures sufficient to fracture a reservoir formation to allow hydrocarbons to more easily flow from the formation toward a wellbore for production. Such high rates of flow and high pressures may result in significant wear to components associated with the fluid flow, such as the pumps used to pump the fracturing fluid. In addition, the fracturing fluid may contain substances, for example, proppants and fluids, having abrasive and corrosive characteristics, and thus, components associated with the fracturing operation may exhibit high wear rates or high failure rates. As a result, components associated with pumps, such as valves and seals, may be particularly susceptible high wear rates and failures, thereby requiring maintenance, repair, or replacement, which may increase downtime for the hydraulic fracturing operation and reduce efficiency and productivity. For example, the seals and valves may degrade with use in such harsh conditions, for example, such that the seals may become damaged, lose their shape, or become misaligned relative to other components in the valves, creating leakage at the seals that reduces the efficiency and capabilities of the pump.

For at least these reasons, Applicant has recognized that it may be desirable to provide valves and seals having relatively longer service lives that reduce downtime associated with use in a high-pressure pump. At least some examples described herein may address one or more of the above-noted potential issues, as well as possibly others.

### SUMMARY

As referenced above, it may be desirable to provide valves and seals having relatively longer service lives that reduce downtime associated with use in a high-pressure pump, such as, for example, valves and seals used in the oil and gas industry, where the operating conditions and fluids may present a particularly harsh environment. In some embodiments, the systems, assemblies, apparatuses, and methods presented herein may provide a relatively enhanced engagement between components, such as valve members and valve seals, which may result in relatively reduced damage, deformation, displacement, wear, and/or leakage associated with valve assemblies including the valve members and valve seals. For example, in some embodiments, a valve body and an associated valve seal may be configured to engage one another to thereby reduce or prevent relative displacement of the valve seal with respect to the valve body during operation of a high-pressure pump including the valve assembly.

According to some embodiments, a valve member to enhance sealing of a fluid flow in a high-pressure pump assembly may include a valve body defining a valve body axis and including a valve head having a first radial dimension and extending in a direction transverse to the valve body axis, and a neck portion connected to the valve head and having a second radial dimension less than the first radial dimension. One or more of the valve head or the neck portion may include a seal engaging surface at least partially defining one or more recesses. The valve member further may include a valve seal connected to the valve body around the neck portion and adjacent the seal engaging surface of the valve body. The valve seal may include a body engaging surface having one or more protrusions positioned against the seal engaging surface and received in the one or more recesses to form an engagement between the valve seal and the valve body. The engagement, during operation of the high-pressure pump assembly, may resist one or more of: (a) outward radial migration of the valve seal relative to the seal engaging surface of the valve body, (b) axial displacement of the valve seal relative to the seal engaging surface of the valve body, or (c) rotational displacement of the valve seal relative to the seal engaging surface of the valve body.

According to some embodiments, a valve assembly to enhance sealing of a fluid flow in a high-pressure pump assembly may include a valve member positioned to move between an open position allowing fluid flow through the valve assembly and a closed position preventing fluid flow through the valve assembly. The valve member may include a valve body defining a valve body axis and including a valve head having a first radial dimension, and a neck portion connected to the valve head and having a second radial dimension less than the first radial dimension and extending in a direction transverse to the valve body axis. One or more of the valve head or the neck portion may include a seal engaging surface at least partially defining one or more recesses. The valve member further may include a valve seal connected to the valve body around the neck portion and adjacent the seal engaging surface. The valve seal may include a body engaging surface including one or more protrusions positioned against the seal engaging surface and received in the one or more recesses to form an engagement between the valve seal and the valve body, such that during operation of the high-pressure pump assembly the engagement resists one or more of: (a) outward radial migration of the valve seal relative to the seal engaging surface of the valve body, (b) axial displacement of the valve seal relative to the seal engaging surface of the valve body, or (c) rotational displacement of the valve seal relative to the seal engaging surface of the valve body. The valve seal further may include a seat engaging surface, and the valve assembly further may include a valve seat including a substantially cylindrical body at least partially defining an opening therethrough and a seat surface. The seat surface may be positioned to abut the seat engaging surface of the valve seal to thereby prevent fluid flow through the valve assembly.

According to some embodiments, a fluid end assembly for a high-pressure reciprocating pump may include a manifold block at least partially defining a pump chamber and a manifold passage positioned to provide fluid communication with the pump chamber. The fluid end assembly further may include a valve assembly received in the manifold passage of the manifold block and positioned control fluid flow through the manifold passage. The valve assembly may include a valve member positioned to move between an open position allowing fluid flow through the valve assembly and a closed position preventing fluid flow through the valve assembly. The valve member may include a valve body defining a valve body axis and including a valve head having a first radial dimension and extending in a direction transverse to the valve body axis, and a neck portion connected to the valve head and having a second radial dimension less than the first radial dimension. One or more of the valve head or the neck portion further may include a seal engaging surface at least partially defining one or more recesses. The valve member further may include a valve seal connected to the valve body around the neck portion and adjacent the seal engaging surface. The valve seal may include a body engaging surface including one or more protrusions positioned against the seal engaging surface and received in the one or more recesses to form an engagement between the valve seal and the valve body, such that during operation of the high-pressure pump assembly the engagement resists one or more of: (a) outward radial migration of the valve seal relative to the seal engaging surface of the valve body, (b) axial displacement of the valve seal relative to the seal engaging surface of the valve body, or (c) rotational displacement of the valve seal relative to the seal engaging surface of the valve body. The valve seal further may include a seat engaging surface, and the valve assembly further may include a valve seat including a substantially cylindrical body at least partially defining an opening therethrough and a seat surface. The seat surface may be positioned to abut the seat engaging surface of the valve seal to thereby prevent fluid flow through the valve assembly.

According to some embodiments, a method for enhancing engagement between a valve seal and a valve body of a valve member for sealing fluid flow in a high-pressure pump may include providing a valve body defining a valve body axis and a including a valve head having a first radial dimension and extending in a direction transverse to the valve body axis, and a neck portion connected to the valve head and having a second radial dimension less than the first radial dimension. The method further may include providing one or more recesses in a seal engaging surface of one or more of the valve head or the neck portion. The method also may include positioning a valve seal around the neck portion of the valve body, the valve seal having a body engaging surface and being positioned such that one or more protrusions of the body engaging surface engage the one or more recesses in the seal engaging surface of the valve body and form an engagement between the valve seal and the valve body, and such that during operation of the high-pressure pump the engagement resists one or more of: (a) outward radial migration of the valve seal relative to the seal engaging surface of the valve body, (b) axial displacement of the valve seal relative to the seal engaging surface of the valve body, or (c) rotational displacement of the valve seal relative to the seal engaging surface of the valve body.

Still other aspects and advantages of these exemplary embodiments and other embodiments, are discussed in detail herein. Moreover, it is to be understood that both the foregoing information and the following detailed description provide merely illustrative examples of various aspects and embodiments and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than may be necessary for a fundamental understanding of the embodiments discussed herein and the various ways in which they may be practiced. According to common practice, the various features of the drawings discussed below are not necessarily drawn to scale. Dimensions of various features and elements in the drawings may be expanded or reduced to more clearly illustrate embodiments of the disclosure.

FIG. 1 is a schematic partial section view of an example fluid end assembly including an example intake valve assembly and an example discharge valve assembly, according to embodiments of the disclosure.

FIG. 2A is a schematic section view of an example valve assembly in an open condition in an example fluid end assembly, according to embodiments of the disclosure.

FIG. 2B is a detailed schematic section view of a portion of another example valve assembly in an open condition in an example fluid end assembly, according to embodiments of the disclosure.

FIG. 3 is a schematic perspective view of an example valve assembly including an example valve member and an example valve seat, according to embodiments of the disclosure.

FIG. 4 is a schematic side view of the example valve member including an example valve body and an example valve seal, according to embodiments of the disclosure.

FIG. 5 is a schematic side view of an example valve body, according to embodiments of the disclosure.

FIG. 6 is a schematic side section view of the example valve body shown in FIG. 5 as viewed along line P-P, according to embodiments of the disclosure.

FIG. 7A is a partial section view of a portion of an example valve body including an example recess, according to embodiments of the disclosure.

FIG. 7B is a partial section view of a portion of another example valve body including another example recess, according to embodiments of the disclosure.

FIG. 7C is a partial section view of a portion of another example valve body including example recesses, according to embodiments of the disclosure.

FIG. 8 is a partial schematic perspective view of a portion of an example valve member including an example valve seal engaged with an example valve body, according to embodiments of the disclosure.

FIG. 9A is a partial section view of the example valve body and example valve seal shown in FIG. 8 as viewed along line R-R, according to embodiments of the disclosure.

FIG. 9B is partial section view of another example valve body and example valve seal as shown in FIG. 8 as viewed along line R-R, according to embodiments of the disclosure.

FIG. 10 is a schematic section view of an example valve seal, according to embodiments of the disclosure.

FIG. 11A is a partial section view of an example valve seal including an example body engaging surface, according to embodiments of the disclosure.

FIG. 11B is a partial section view of an example valve seal including another example body engaging surface, according to embodiments of the disclosure.

FIG. 11C is a partial section view of an example valve seal including another example body engaging surface, according to embodiments of the disclosure.

FIG. 12 is a block diagram of an example method for enhancing engagement between a valve seal and a valve body of a valve member for sealing fluid flow in a high-pressure pump, according to embodiments of the disclosure.

### DETAILED DESCRIPTION

The drawings include like numerals to indicate like parts throughout the several views, the following description is provided as an enabling teaching of exemplary embodiments, and those skilled in the relevant art will recognize that many changes may be made to the embodiments described. It also will be apparent that some of the desired benefits of the embodiments described may be obtained by selecting some of the features of the embodiments without utilizing other features. Accordingly, those skilled in the art will recognize that many modifications and adaptations to the embodiments described are possible and may even be desirable in certain circumstances. Thus, the following description is provided as illustrative of the principles of the embodiments and not in limitation thereof.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, in particular, to mean “including but not limited to,” unless otherwise stated. Thus, the use of such terms is meant to encompass the items listed thereafter, and equivalents thereof, as well as additional items. The transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish claim elements.

Pumps often include valves to control the flow of fluid into, from, and/or through a pump chamber of the pump. For example, a reciprocating plunger pump may be used to pump a fracturing fluid at high flow rates and high pressures sufficient to fracture a reservoir formation to allow hydrocarbons to more easily flow from the formation toward a wellbore for production. A hydraulic fracturing operation may include as many as six or more hydraulic fracturing units, and each of the hydraulic fracturing units may include a prime mover, such as an electric motor or internal combustion engine, either directly connected, or connected via a transmission, to the reciprocating plunger pump to supply power to drive the reciprocating plunger pump to pump the fracturing fluid into the formation to stimulate production of the well. For example, typical flow rates for a hydraulic fracturing operation may range from about 1,500 to about 4,000 gallons per minute, and typical pressures may range from about 7,500 to about 15,000 pounds per square inch. Although many examples discussed in this disclosure are explained in relation to hydraulic fracturing equipment, such as reciprocating plunger pumps for pumping fracturing fluid and related methods, other flow control-related and/or pumping-related operations, components, and methods are contemplated.

As an example, a reciprocating plunger pump may include a power end assembly and a fluid end assembly. The power end assembly may include, for example, a housing with mechanical power transmission components, such as a crankshaft, bearings supporting the crankshaft in the housing, crossheads, reduction gears, and/or connecting rods and plungers connected to the connecting rods. The fluid end assembly may include, for example, a manifold block including one or more cylinders in which respective plungers reciprocate, one or more chambers receiving fluid, and one or more fluid passages for drawing fluid into the one or more chambers and discharging fluid from the one or more chambers at a higher pressure. For example, as each plunger, moved via operation of the crankshaft and a respective connecting rod, at least partially retracts into a respective cylinder, fluid is drawn into the chamber of the fluid end assembly via an intake passage in the manifold block while an intake valve is open and a discharge valve is closed. As each plunger extends back toward the chamber, moved via operation of the crankshaft and the respective connecting rod, pressurized fluid is discharged from the fluid end assembly via a discharge passage in the manifold block while the discharge valve is open and the intake valve is closed. The intake and discharge valves may be one-way valves or check valves, allowing fluid to flow only in a single direction, either into the manifold block via the intake valve, or from the manifold block via the discharge valve. In this example manner, the fluid end assembly draws fluid into the fluid end assembly at low pressure and discharges the fluid from the fluid end assembly at a higher pressure. In some pumps, the fluid end assembly may include multiple (e.g., two, three, four, or five) sets of intake passages, cylinders, plungers, and discharge passages to pump fluid at high pressures and/or high flow rates.

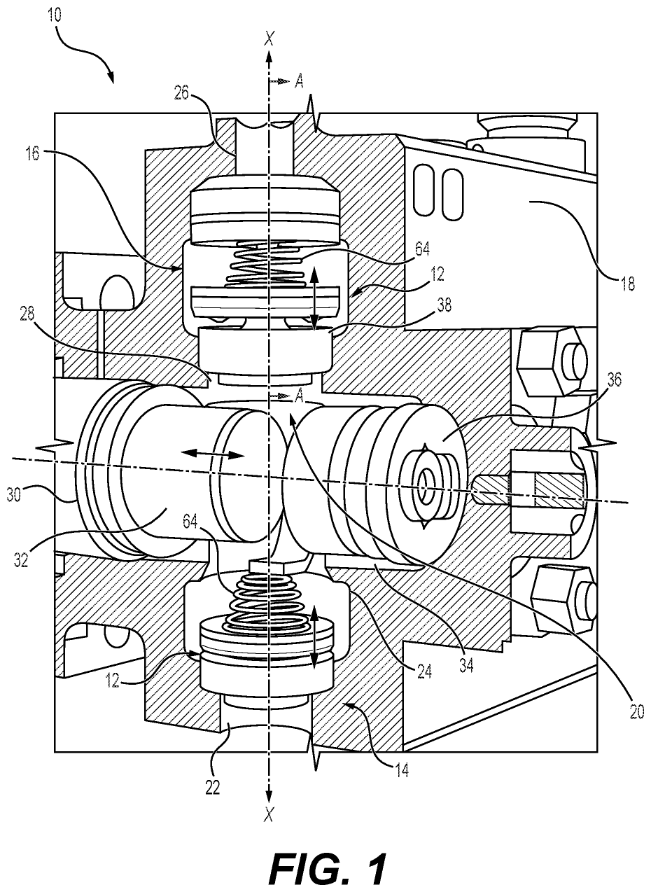

FIG. 1 is a schematic partial section view of an example fluid end assembly 10 for a high-pressure pump, including two example valve assemblies 12, such as an example intake valve assembly 14 and an example discharge valve assembly 16 of the fluid end assembly 10, according to embodiments of the disclosure. As shown in FIG. 1, some embodiments of the fluid end assembly 10 may include a manifold block 18 at least partially defining a pump chamber 20, an intake manifold passage 22 terminating at the pump chamber 20 at an intake port 24, and a discharge manifold passage 26 terminating at the pump chamber 20 at a discharge port 28. Both the intake manifold passage 22 and the discharge manifold passage 26 may be positioned to provide fluid communication with the pump chamber 20. In the embodiment shown, the intake valve assembly 14 may be received in the intake manifold passage 22 of the manifold block 18 and may be positioned control fluid flow through the intake manifold passage 22. The discharge valve assembly 16 may be received in the discharge manifold passage 26 of the manifold block 18 and may be positioned control fluid flow through the discharge manifold passage 26. In some embodiments, the fluid end assembly 10 further may include a cylinder 30 or plunger bore and a respective plunger 32 received in the cylinder 30 and positioned and configured to reciprocate within the cylinder 30, for example, as described herein. In some embodiments, the fluid end assembly 10 may include multiple (e.g., two, three, four, or five) sets of intake manifold passages 22, cylinders 30, plungers 32, and discharge manifold passages 26 to pump fluid at high pressures and/or high flow rates. As shown in FIG. 1, some embodiments of the fluid end assembly 10 further may include one or more access bores 34 positioned and configured to provide access to the pump chamber 20 and one or more removable access covers 36 received in the one or more access bores 34 and positioned and configured to seal the one or more access bores 34 during operation of the fluid end assembly 10 and to be removed from the access bores 34 to provide access to the pump chamber 20.

According to some embodiments, during operation of a reciprocating plunger pump, the power end assembly 10 may be driven by a primer over, such as an electric motor and/or an internal combustion engine, which may be connected via a transmission and/or one or more couplings to a crankshaft of the pump. The crankshaft may be connected to one or more connecting rods, each of which may be connected to a respective plunger 32, and rotation of the crankshaft may cause the one or more plungers 32 to reciprocate within one or more corresponding cylinders 32 of the fluid end assembly 10. As each of the one or more plungers 32 at least partially retracts into a respective cylinder 30, fluid is drawn into the pump chamber 20 of the fluid end assembly 10 via the intake manifold passage 22 in the manifold block 18 while the intake valve assembly 14 is in an open condition and the discharge valve assembly 16 is in a closed condition. As each plunger 32 extends within the cylinder 30 back toward the pump chamber 20, pressurized fluid is discharged from the fluid end assembly 10 via the discharge manifold passage 26 in the manifold block 18 while the discharge valve assembly 16 is in an open condition and the intake valve assembly 14 is in a closed condition. In some embodiments, the intake valve assembly 14 and/or the discharge valve assembly 16 may be one-way valves or check valves, allowing fluid to flow only in a single direction, either into the manifold block 18 via the intake valve assembly 14 and the intake port 24, or from the manifold block 18 via the discharge port 28 and the discharge valve assembly 16. Other types of valves are contemplated. In this example manner, the fluid end assembly 10 draws fluid into the fluid end assembly 10 at relatively low pressure and discharges the fluid from the fluid end assembly 10 at a relatively higher pressure.

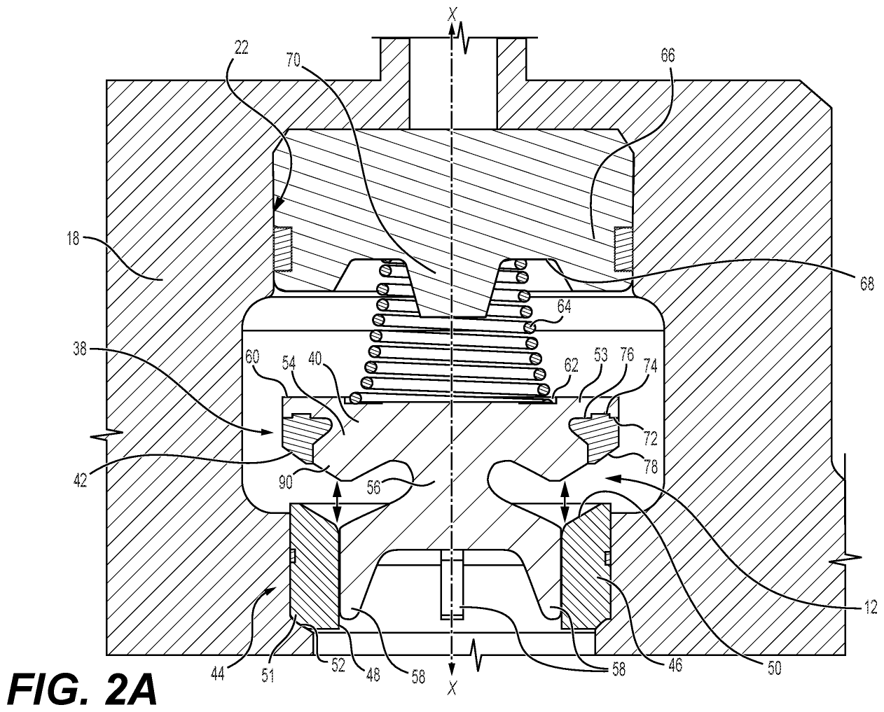

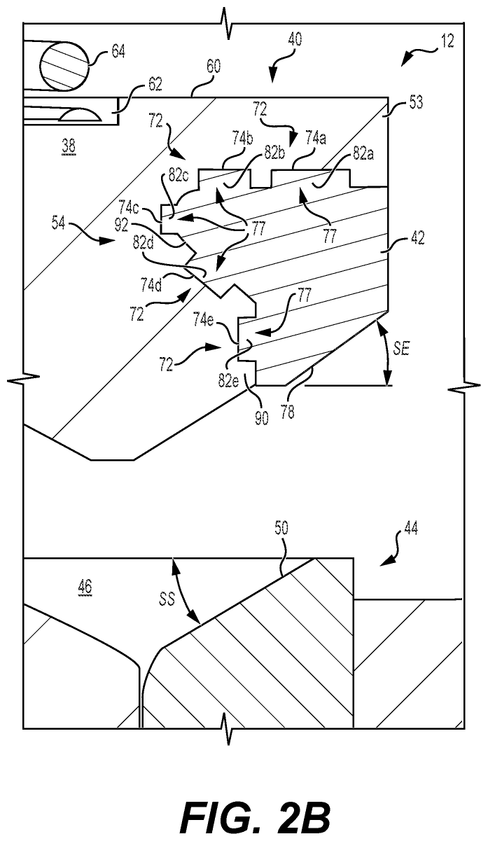

FIG. 2A is a schematic section view of an example valve assembly 12 in an open condition in an example fluid end assembly 10, according to embodiments of the disclosure. As shown in FIG. 1 and FIG. 2A, some embodiments of the valve assembly 12 may include a valve member 38 positioned in the valve assembly 12 to move between an open position allowing fluid flow through the valve assembly 10 (e.g., as shown in FIG. 2A) and a closed position preventing fluid flow through the valve assembly 12. As shown, some embodiments of the valve member 38 may include a valve body 40 and a valve seal 42 connected to the valve body 40. The valve assembly 12 further may include a valve seat 44 including a substantially cylindrical valve seat body 46 at least partially defining an opening 48 therethrough and a seat surface 50. The seat surface 50 may be positioned and configured to abut the valve seal 42 to thereby prevent fluid flow through the valve assembly 12 and the intake manifold passage 22 or discharge manifold passage 26, depending on the location and function of the valve assembly 12 in the manifold block 18.

In some embodiments, as shown in FIG. 2A, the valve seat body 46 also may include a tapered end 51 at an end of the valve seat body 46 opposite the seat surface 50 and configured to abut or engage a passage shoulder 52 of the intake manifold passage 22 and/or the discharge manifold passage 26, depending on the location of the valve assembly 12. The valve seat body 46, in some embodiments, may be configured to be installed in the intake manifold passage 22 and/or the exhaust manifold passage 26 via a press fit, for example, to abut the passage shoulder 52, and in some embodiments, the exterior surface of the valve seat body 46 may include external threads configured to be threadedly engaged with internal threads in the intake manifold passage 22 and/or the discharge manifold passage 26.

As shown in FIG. 2A, in some embodiments, the valve body 40 defines a longitudinal valve body axis X and may include a valve head 53 having a first radial dimension D1 (e.g., a diameter), and a neck portion 54 connected to the valve head 53 and having a second radial dimension D2 (e.g., a diameter) less than the first radial dimension D1. For example, the valve head 53, in some embodiments, may have a substantially circular cross-section as viewed perpendicular to the longitudinal valve body axis X and may be substantially disc-shaped. In some embodiments, the valve body 40 further may include a stem 56 extending from the neck portion 54 in a direction opposite the valve head 53 and one or more legs 58 extending axially from the stem 56 in a direction opposite the neck portion 54. In some embodiments, the one or more legs 58 may extend axially from the valve head 53 or the neck portion 54, for example, and not from a stem.

In some embodiments, components of the valve assembly 12, such as the valve body 40, the valve seat 44, and the spring retainer 66, may include, or be formed from, metal, such as, for example, stainless steel and/or other similar metals. Metallic surfaces of the components may be surface-treated, heat-treated, carburized, nitride-treated, peening, and/or subjected to other surface-treating procedures to increase the durability and/or wear-resistance of the surfaces. For example, some components may be case-hardened in a furnace at a uniform temperature above a critical temperature threshold (e.g., a microstructural transformation temperature for the material), followed by a rapid quenching to produce a lattice and/or grain structure with improved wear performance characteristics.

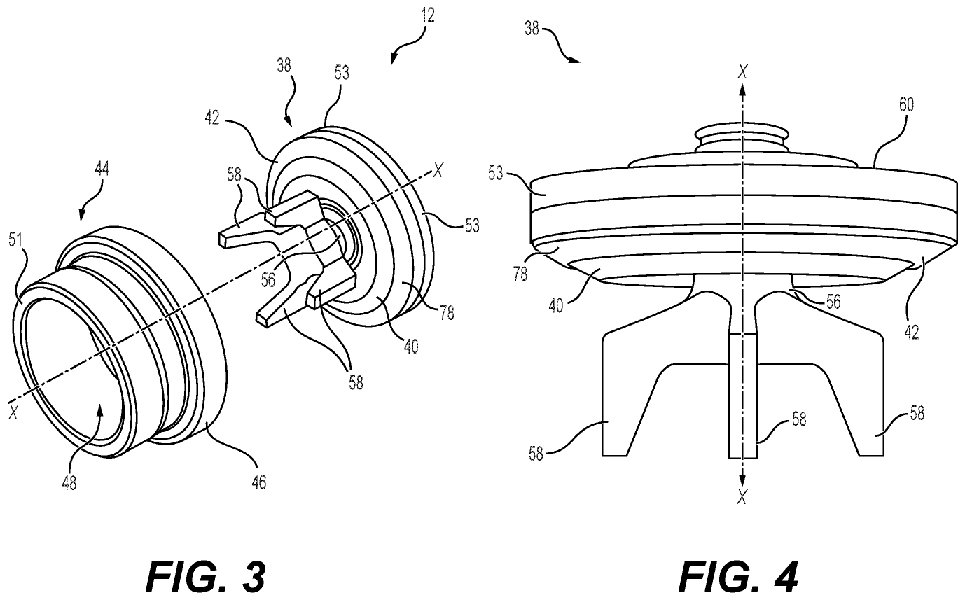

FIG. 3 is a schematic perspective view of an example valve assembly 10 including an example valve member 38 and an example valve seat 44, according to embodiments of the disclosure, and FIG. 4 is a schematic side view of the example valve member 38 including an example valve body 40 and an example valve seal 42, according to embodiments of the disclosure. In some embodiments, the one or more legs 58 may include four legs, although other numbers of legs 58 are contemplated, and in embodiments having two or more legs 58, the legs 58 may arranged symmetrically and in some embodiments, the legs may be axisymmetric with respect to the valve body axis X (e.g., as shown in FIGS. 3 and 4). Some embodiments of the valve body 40 may include three legs 58, and in some embodiments, the legs 58 may be asymmetric with respect to the valve body axis X. In some embodiments, the one or more legs 58 may be configured to substantially align and/or center the valve member 38 in the valve seat body 46, for example, as the valve member 38 reciprocates between the open and closed positions. For example, as shown in FIG. 2A, the radially outer surfaces of distal ends of the legs 58 opposite the stem 56 may ride and/or slide along the interior surface of the opening 48 in the valve seat body 46.

As shown in FIG. 2A, in some embodiments, the valve head 53 may be located at a proximal end of the valve body 40 and may include a valve head surface 60 facing in a direction away from the valve seal 42. In some embodiments, the valve head surface 60 may at least partially define a spring recess 62, and the valve assembly 10 further may include a valve spring 64 having an end abutting the spring recess 62 and biasing the valve member 38 against the valve seat 44. As shown in FIG. 2A, the valve assembly 12 may further include a spring retainer 66 opposite the valve head surface 60 and the spring recess 62 and configured to provide a support for the valve spring 64, which may provide a biasing force against the valve member 38. In some embodiments, the spring retainer 66 may include retainer recess 68 configured to receive therein an end of the valve spring 64 opposite the valve member 38. In some embodiments, the retainer recess 68 may be a substantially annular recess, and the spring retainer 66 may include a spring centering boss 70 positioned and configured to substantially maintain alignment of the valve spring 64 relative to the valve member 38. As shown in FIG. 2A, the valve spring 64 is at least partially compressed, such that the valve member 38 has moved away from the valve seat 44 to an open position, thereby opening the valve assembly 12 and allowing fluid to pass between the valve seal 42 and the seat surface 50 of the valve seat 44, through the legs 58 of the valve body 40, and through the valve assembly 10. In some embodiments, the valve spring 64 may be selected to provide a biasing force to close the valve assembly 12, for example, to maintain the valve seal 42 against the seat surface 50 of the valve seat 44 until fluid pressure of fluid pressing against the valve member 38 reaches a predetermined magnitude and overcomes the biasing force, thereby allowing fluid to flow through the valve assembly 12, for example, until the fluid pressure drops below a predetermined magnitude.

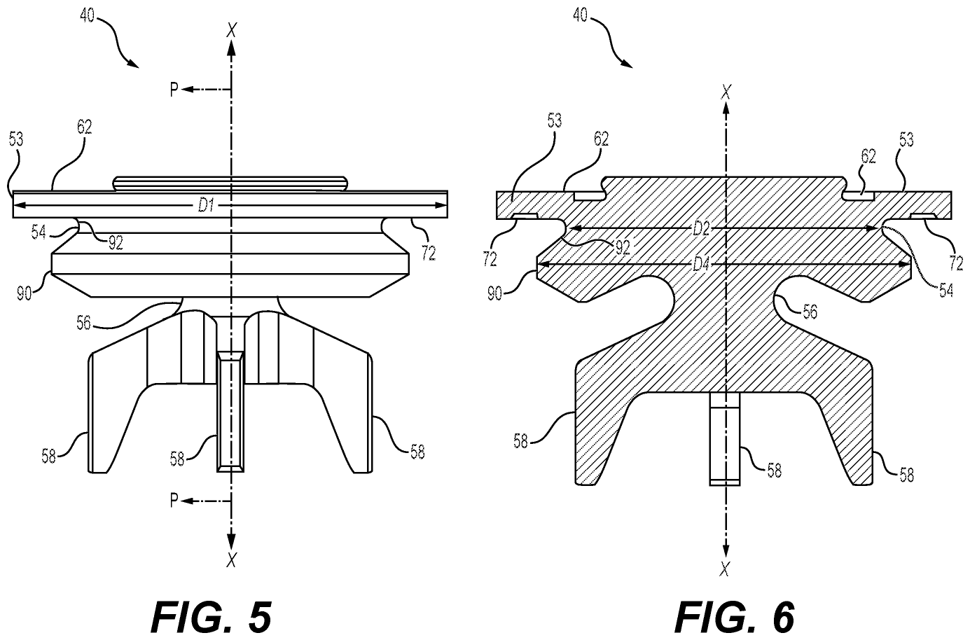

FIG. 5 is a schematic side view of an example valve body 40, according to embodiments of the disclosure, and FIG. 6 is a schematic side section view of the example valve body 40 shown in FIG. 5 as viewed along line P-P, according to embodiments of the disclosure. As shown in FIG. 2A, FIG. 2B, and FIG. 6, in some embodiments, the valve body 40 (e.g., the valve head 53 of the valve body 40) may include a seal engaging surface 72 at least partially defining one or more recesses 74. In some embodiments, the seal engaging surface 72 may be adjacent the neck portion 54 of the valve body 40 and may at least partially define one or more recesses 74, for example, as shown in FIG. 2A.

FIG. 2B is a detailed schematic section view of a portion of another example valve assembly 12 in an open condition in an example fluid end assembly, according to embodiments of the disclosure. As shown in FIG. 2B, in some embodiments, the seal engaging surface 72 may be adjacent the neck portion 54, may extend along the neck portion 54, may extend past the next portion 54, may extend obliquely relative to the valve body axis X, and/or extend substantially parallel to the valve body axis X. In some embodiments, the seal engaging surface 72 may extend in an at least substantially contiguous manner along an interface between the valve body 40 and the valve seal 42, for example, where the valve body 40 and the valve seal 42 contact one another. As shown in FIG. 2B, in some embodiments, the seal engaging surface 72 may include a plurality of recesses 74, for example, recesses 74a, 74b, 74c, 74d, and 74e, as shown.

The valve seal 42 may be connected to the valve body 40 around the neck portion 54 and adjacent the seal engaging surface 72. In some embodiments, the valve seal 42 may include a body engaging surface 76 positioned against the seal engaging surface 72 of the valve body 53, for example, such that an engagement portion 77 of the body engaging surface 76 of the valve seal 42 is received in the one or more recesses 74 to form an engagement (e.g., a mechanical engagement) between the valve seal 42 and the valve body 40, for example, as shown in FIG. 2A. As shown in FIG. 2B, in some embodiments, the valve seal 42 may include a body engaging surface 76 positioned against the seal engaging surface 72, for example, such that engagement portions 77 of the body engaging surface 76 of the valve seal 42 are received in the plurality recesses 74 (e.g., recesses 74a, 74b, 74c, 74d, and 74e) to form an engagement (e.g., a mechanical engagement) between the valve seal 42 and the valve body 40. In some embodiments, the engagement between the body engaging surface 76 of the valve seal 42 and the one or more recesses 74 of the seal engaging surface 72 may form an engagement between the valve seal 42 and the valve body 40 that, during operation of the of a high-pressure pump assembly in which the valve assembly 12 has been placed, resists one or more of: (a) outward radial migration of the valve seal 42 relative to the seal engaging surface 72 of the valve body 40, (b) axial displacement of the valve seal 42 relative to the seal engaging surface 72 of the valve body, or (c) rotational displacement of the valve seal 42 relative to the seal engaging surface 72 of the valve body 40.

In some embodiments, for example as shown FIGS. 2A, 2B, 5, and 6, the valve head surface 60 of the valve body 40, the seal engaging surface 72 of the valve body 40, and/or the body engaging surface 76 of the valve seal 42 may be substantially perpendicular to the valve body axis X. In some embodiments, the valve head surface 60 of the valve body 40, the seal engaging surface 72 of the valve body 40, and/or the body engaging surface 76 of the valve seal 42 may be substantially oblique with relative to the valve body axis X.

The valve seal 42, in some embodiments, further may include a seat engaging surface 78 positioned and configured to engage the seat surface 50 of the valve seat 44. When the valve member 38 is in the closed position, the seat engaging surface 78 and the seat surface 50 of the valve seat 44 may abut one another, thereby sealing the valve assembly 12 in the closed condition to thereby prevent fluid flow through a valve assembly 12. For example, the seat engaging surface 72 of the valve seal 42 and the seat surface 50 of the valve seat 44 may be configured to prevent fluid flow through the opening 48 in the valve seat body 46. In some embodiments, the valve spring 64 may press the seat engaging surface 72 against the seat surface 50, thereby enhancing the seal between the valve seal 42 and the valve seat 44, for example, until fluid pressure in the valve assembly 12 reaches or exceeds a predetermined magnitude, as described herein. In some embodiments, the seat engaging surface 78 may be substantially annular and may extend in a direction oblique with respect to the valve body axis X, and the seat surface 50 of the valve seat 44 may be substantially annular and may extend in a direction oblique with respect to the valve body axis X. In some embodiments, the seat surface 50 of the valve seat 44 may extend in a direction substantially parallel to the seat engaging surface 78, for example, as shown in FIGS. 2A and 2B. In some embodiments, the seat engaging surface 78 may extend in a direction perpendicular with respect to the valve body axis X, and the seat surface 50 of the valve seat 44 may extend in a direction substantially parallel to the seat engaging surface 78. In some embodiments, the seat surface 50 and/or the seat engaging surface 78 may be curved and/or tapered, for example, to enhance the seal between the seat surface 50 and the seat engaging surface 78.

Referring to FIG. 2B, in some embodiments, the seat engaging surface 78 may extend in a direction forming seat engaging angle SE with respect to a plane perpendicular to the valve body axis X, and the seat surface 50 may extend in a direction forming a seat surface angle SS with respect to a plane perpendicular relative to the valve body axis X. In some embodiments, the seat engaging angle SE may be substantially equal to the seat surface angle SS, such that the seat surface 50 of the valve seat 44 may extend in a direction substantially parallel to the seat engaging surface 78. In some embodiments, the seat engaging angle SE may differ from the seat surface angle SS. For example, the seat surface angle SS of the seat surface 50 of the valve seat 44 may range from about 20 degrees to about 40 degrees, such as, for example, from about 25 degrees to about 40 degrees, from about 30 degrees to about 40 degrees, from about 35 degrees to about 40 degrees, from about 20 degrees to about 35 degrees, from about 20 degrees to about 30 degrees, from about 20 degrees to about 25 degrees, or from about 25 degrees to about 35 degrees (e.g., about 30 degrees). In some embodiments, the seat engaging angle SE of the seat engaging surface 78 of the valve seal 42 (e.g., in a condition uncompressed and/or undeformed by pressure against the seat surface 50) may range from about 20 degrees to about 40 degrees, such as, for example, from about 25 degrees to about 40 degrees, from about 30 degrees to about 40 degrees, from about 35 degrees to about 40 degrees, from about 20 degrees to about 35 degrees, from about 20 degrees to about 30 degrees, from about 20 degrees to about 25 degrees, or from about 25 degrees to about 35 degrees (e.g., about 30 degrees). In some embodiments, the seat engaging angle SE may range from about 15 degrees less than the seat surface angle SS to about 15 degrees greater than the seat surface angle SS, such as, for example, from about 10 degrees less than the seat surface angle SS to about 10 degrees greater than the seat surface angle SS, from about 10 degrees less than the seat surface angle SS to about 5 degrees greater than the seat surface angle SS, from about 5 degrees less than the seat surface angle SS to about 10 degrees greater than the seat surface angle SS, or from about 5 degrees less than the seat surface angle SS to about 5 degrees greater than the seat surface angle SS.

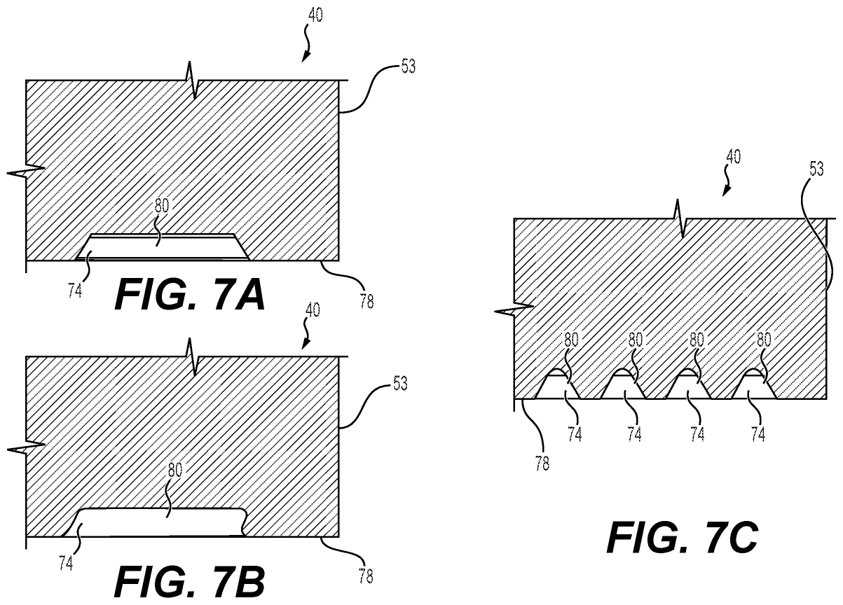

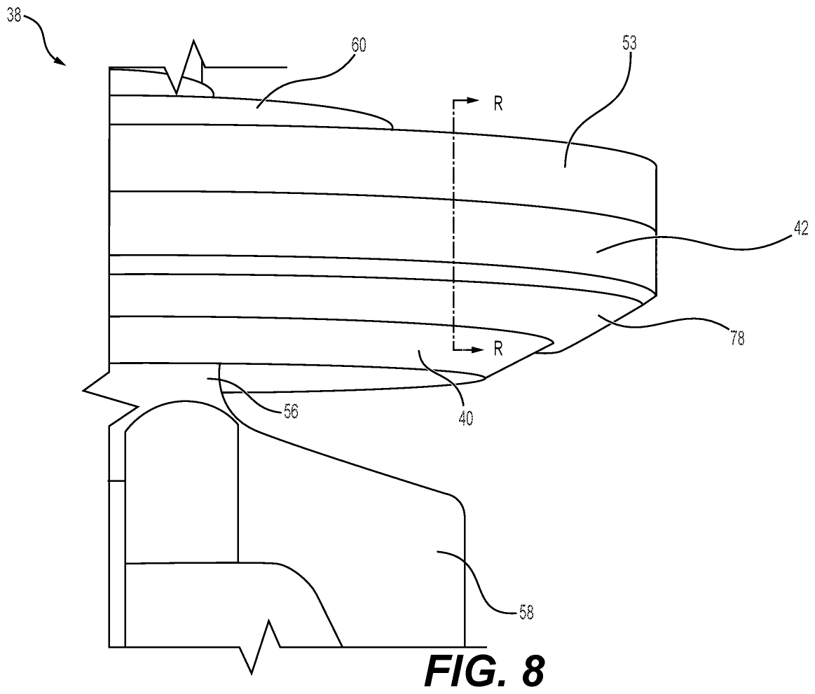

FIG. 7A, FIG. 7B, and FIG. 7C are partial section views of respective portions of example valve bodies 40 including example recesses 74 of respective seal engaging surfaces 72, according to embodiments of the disclosure. As shown in FIGS. 7A-7C, the seal engaging surface 72 of the valve body 40 may include one or more recesses 74 configured to engage (e.g., mechanically engage) the valve seal 42. In some embodiments, the one or more recesses 74 may include a substantially annular recess having a substantially polygonal-shaped cross-section 80, for example, as shown FIGS. 7A-7C. The one or more recesses 74 may include, for example, one or more notches, grooves, depressions, and/or other similar geometries configured to receive and/or engage the body engaging surface 76 of the valve seal 42. The one or more recesses 74 may be machined into the surface of the valve body 40, cast, and/or may include a surface shell or overlay including the one or more recesses 74. The one or more recesses 74 may provide an engagement (e.g., a mechanical engagement) between the valve seal 42 and the valve body 40 (e.g., between the valve seal 42 and the valve head 53), for example, in two or more dimensions (e.g., radially and or longitudinally) to reduce the likelihood or prevent the valve seal 42 from migrating radially outward with use. In some embodiments, this example engagement may eliminate or reduce the need to use adhesives and/or fasteners to maintain a desired relationship between the valve seal 42 and the valve body 40 (e.g., between the valve seal 42 and the valve head 53) during the service life of the valve member 38, and/or may supplement the use of adhesives and/or fasteners.

As shown in FIG. 7A, in some embodiments, the cross-section 80 of the one or more recesses 74 may be substantially trapezoidal-shaped. Although only a single recess 74 is shown in FIG. 7A, in some embodiments, the seal engaging surface 72 may include more than a single recess 74 having a trapezoidal-shaped cross-section 80, for example, substantially concentric recesses 74, each having a trapezoidal-shaped cross-section 80.

As shown in FIG. 7B, the cross-section 80 of the one or more recesses 74 may be substantially parallelogram-shaped. Although only a single recess 74 is shown in FIG. 7B, in some embodiments, the seal engaging surface 72 may include more than a single recess 74 having a parallelogram-shaped cross-section 80, for example, substantially concentric recesses 74, each having a parallelogram-shaped cross-section 80.

As shown in FIG. 7C, the cross-section 80 of the one or more recesses 74 may be or present a substantially serrated cross-section. For example, the cross-section 80 may include several substantially triangular-shaped recesses 74 that collectively form a serrated cross-section, for example, as shown in FIG. 7C.

Although FIGS. 7A, 7B, and 7C show examples of recesses 74 having several example cross-sections 80 and several cross-sectional shapes, recesses 74 having other cross-sectional shapes are contemplated. In some embodiments, the seal engaging surface 72 of the valve body 40 may include multiple recesses 74, and the multiple recesses 74 may include one or more recesses 74 having a different cross-sectional shape than one or more others of the multiple recesses 74.

In some embodiments, the body engaging surface 76 of the valve seal 42 may include one or more protrusions 82 having a cross-sectional shape substantially complimentary to the shape of the one or more respective cross-sections 80 of the one or more recesses 74 of the seal engaging surface 72 of the valve body 40.

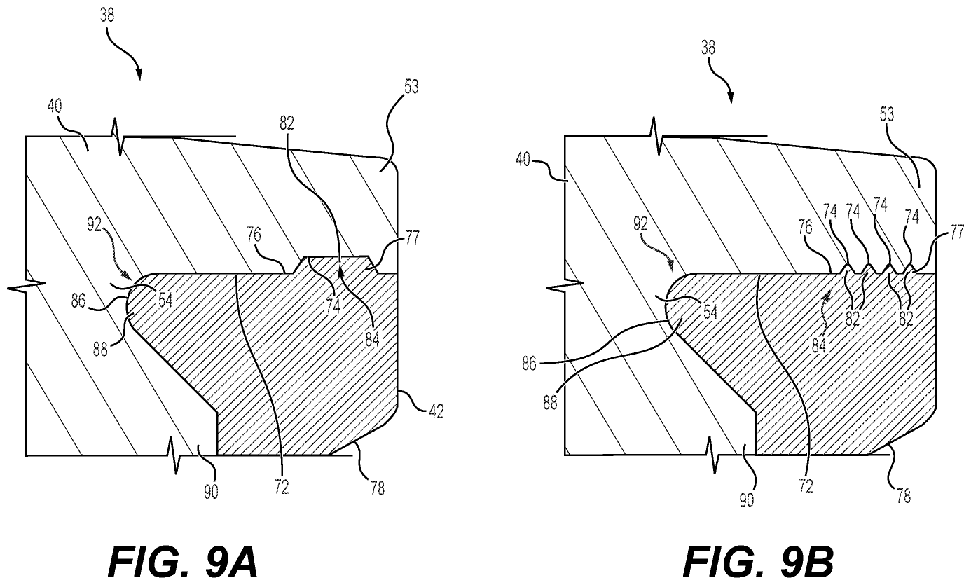

FIG. 8 is a partial schematic perspective view of a portion of an example valve member 38 including an example valve seal 42 engaged with an example valve body 40, according to embodiments of the disclosure, and FIG. 9A is a partial section view of the example valve body 40 and the example valve seal 42 shown in FIG. 8, as viewed along line R-R, according to embodiments of the disclosure. As shown in FIGS. 8 and 9A, in some embodiments, the one or more recesses 74 may include one or more substantially annular recesses 74 having substantially polygonal-shaped cross-sections 80, and the body engaging surface 76 of the valve seal 42 may include one or more protrusions 82 having a cross-sectional shape substantially complimentary to the substantially polygonal-shaped cross-sections 80 of the one or more substantially annular recesses 74. For example, the one or more protrusions 82 may have a cross-section 84 that is substantially polygonal-shaped. In some embodiments, the one or more recesses 74 may include one or more substantially annular recesses 74 having substantially trapezoidal-shaped cross-sections 80, and the body engaging surface 76 of the valve seal 42 may include one or more protrusions 82 having a cross-sectional shape substantially complimentary to the substantially trapezoidal-shaped cross-sections 80 of the one or more substantially annular recesses 74. For example, the one or more protrusions 82 may have a cross-section 84 that is substantially trapezoidal-shaped. In some embodiments, the one or more recesses 74 may include one or more substantially annular recesses 74 having substantially parallelogram-shaped cross-sections 80, and the body engaging surface 76 of the valve seal 42 may include one or more protrusions 82 having a cross-sectional shape substantially complimentary to the substantially parallelogram-shaped cross-sections 80 of the one or more substantially annular recesses 74. For example, the one or more protrusions 82 may have a cross-section 84 that is substantially parallelogram-shaped.

FIG. 9B is partial section view of another example valve body 40 and another example valve seal 42 as shown in FIG. 8 as viewed along line R-R, according to embodiments of the disclosure. As shown in FIG. 9B, in some embodiments, the one or more recesses 74 may include one or more substantially annular recesses 74 forming a substantially serrated cross-section 80, and the body engaging surface 76 of the valve seal 42 may include one or more protrusions 82 having a cross-sectional shape substantially complimentary to the substantially serrated cross-section 80 of the one or more substantially annular recesses 74. For example, the one or more protrusions 82 may have a cross-section 84 that forms a substantially serrated cross-section. Protrusions 82 having different cross-sectional shapes are contemplated.

In some embodiments, the one or more substantially annular recesses 74 may be continuous, and in some embodiments, the one or more substantially annular recesses 74 may be discontinuous, for example, such the that the one or more recesses 74 intermittently end and restart in a substantially circular path, for example, as viewed in a direction substantially aligned with the valve body axis X. In some embodiments, the one or more protrusions 82 of the body engaging surface 76 of the valve seal 42 may be substantially annular and may be continuous, and in some embodiments, the one or more substantially annual protrusions 82 may be discontinuous, for example, such the that the one or more protrusions 82 intermittently end and restart in a substantially circular path, for example, as viewed in a direction substantially aligned with the valve body axis X. In at least some such embodiments, the discontinuities of the protrusions 82 may substantially corresponds to the one or more recesses 72 (e.g., the discontinuous recesses 72). At least some such embodiments may serve to prevent the valve seal 42 from rotating relative to the valve body 40, for example, during operation of a pump in which the valve assembly 12 is received or installed.

In some embodiments, the body engaging surface 76 of the valve seal 42, although including one or more protrusions 82 once the valve member 38 is assembled and/or used, may be substantially devoid of protrusions, for example, prior to assembly of the valve seal 42 to the valve body 40. For example, the seal engaging surface 72 of the valve body 40 may include one or more recesses 74, and the body engaging surface 76 of the valve seal 42 may include, or be formed from, material configured to deform and at least partially conform to the one or more recesses 74 and form the engagement portion 77 and the engagement between the valve seal 42 and the valve body 40. For example, prior to assembly, the body engaging surface 76 of the valve seal 42 may be substantially planar, but following assembly, the biasing force of the valve spring 64 may be sufficient to at least partially compress the valve seal 42, causing the substantially planar surface to deform and begin to fill the one or more recesses 74 of the seal engaging surface 72 of the valve body 40. In some embodiments, with repeated cycling of the valve member 38 between the open and closed positions, for example, during operation of a pump in which the valve assembly 12 is received, the partially deformed body engaging surface 76 of the valve seal 42 may deform to a greater extent and more completely fill the one or more recesses 74 of the seal engaging surface 72 of the valve body 40 (e.g., completely fill the one or more recesses 74 of the seal engaging surface 72), and thus, over time with use, the body engaging surface 76 may form the engagement portion 77, thereby providing an engagement (e.g., a mechanical engagement) between the valve seal 42 and the valve body 40.

In some embodiments, the valve seal 42 may be formed from, for example, an elastically deformable and/or compressible material, such as polymeric materials, rubber, synthetic rubber, and/or other materials having similar characteristics. For example, the valve seal 42 may include, or be formed from, hydrogenated nitrile butadiene rubber (HNBR), a urethane or urethane-like material, and/or any other one or more materials having similar characteristics and/or characteristics suitable for providing a seal to seal off flow of fluids being pumped by a pump in which the valve assembly 12 is received. For example, the valve seal 42, in some embodiments, may include or be formed from a material having a hardness ranging from, for example, about 40 to 70 on the Shore D scale. Some urethanes and/or similar materials may be chemically stable and/or resistant to oils, water, ozone, oxidation, and numerous environmental conditions to which the valve seal 42 may be subjected. Some such materials may be tough while having sufficient compliance to conform to and/or seal with the seat surface 50 of the valve seat 44 when the valve assembly 12 is in a closed condition. In some embodiments, the valve seal 42 may include or be formed from an elastomeric material having a relatively low modulus of elasticity and may serve as an effective damping member to absorb energy caused by the cyclic impact between the valve seal 42 and the valve seat 44 during opening and closing cycles of the valve assembly 12.

In some embodiments, the valve seal 42 may include, or be formed from, two or more materials. For example, the body engaging surface 76 of the valve seal 42 may be include, or be formed from, a relatively hard and/or inelastic material, for example, including one or more protrusions 82 to provide a relatively more secure and/or dimensionally stable engagement with the one or more recesses 74 of the seal engaging surface 72 of the valve body 40. Other portions of the valve seal 74 (e.g., the remainder of the valve seal 42) may include, or be formed from, a relatively more elastic material (e.g., urethane or a urethane-like material), for example, selected to provide a relatively more complete seal with the seat surface 50 of the valve seat 44. At least some such embodiments may serve to provide a relatively more secure engagement between the valve body 40 and the valve seal 42, while also potentially providing a more complete or secure seal between the valve seal 42 and the valve seat 44.

As shown in FIGS. 2A, 2B, 9A, and 9B, for example, in some embodiments, the valve seal 42 may include an inner radial portion 86 adjacent the neck portion 54 of the valve body 40. In some embodiments, the inner radial portion 86 may have a curved cross-sectional profile, for example, with a convex portion of the cross-sectional profile being adjacent the neck portion 54 of the valve body 40. For example, the inner radial portion 86 may form a shoulder 88 configured to be received adjacent the valve head 53 and the neck portion 54 of the valve body 40. As noted herein, in some embodiments, the valve head 53 may have a first radial dimension D1 (FIG. 5, e.g., a diameter), and the neck portion 54 may have a second radial dimension D2 (FIG. 6, e.g., a diameter) less than the first radial dimension D1. In some embodiments, the inner radial portion 86 may at least partially define a third radial dimension D3 (FIG. 6, e.g., a diameter) that, prior to connection to the valve body 40, is less than the second radial dimension D2 of the neck portion 54 of the valve body 40. In some embodiments, the third radial dimension D3 of the inner radial portion 86 of the valve seal 42 may range from about 15% less than the second radial dimension D2 of the neck portion 54 to about 1% less than the second radial dimension D2, such as, for example, from about 12% less to about 1% less, from about 12% less to about 2% less, from about 10% less to about 2% less, from about 8% less to about 2% less, from about 6% less to about 2% less, from about 12% less to about 4% less, from about 12% less to about 6% less, or from about 12% less to about 8% less.

The valve body 40, in some embodiments, may at least partially define a flange 90 located axially between the neck portion 54 and the stem 56 of the valve body 40, for example, as shown in FIGS. 2A, 2B, 6, 9A, and 9B. The flange 90 may at least partially define a fourth radial dimension D4 (FIG. 6, e.g., a diameter) that is greater than the second radial dimension D2 of the neck portion 54 and the third radial dimension D3 of the inner radial portion 86 of the valve seal 42. In some embodiments, the flange 90 may assist with securing the valve seal 42 (e.g., longitudinally) to the valve body 40, once assembled on the valve body 40. For example, during assembly of the valve seal 42 to the valve body 40, the inner radial portion 86 of the valve seal 42 may be stretched to fit over the flange 90, so that the inner radial portion 86 of the valve seal 42 may be received in a pocket 92 (e.g., an annular pocket) at least partially formed by the valve head 53, the neck portion 54, and/or the flange 90 of the valve body 40, for example, as shown in FIGS. 2A, 2B, 6, 9A, and 9B. In some embodiments, this example fit between the pocket 92 and the inner radial portion 86 of the valve seal 42, combined with the engagement between the seal engaging surface 72 of the valve body 40 and the body engaging surface 76 of the valve seal 42, may increase the service life of the valve seal 42, and/or the service life of the valve member 38, for example, by slowing, mitigating, or eliminating deformation of the valve seal 42 with use as the valve member 38 cycles between open and closed conditions.

For example, as a pump operates on its duty cycle, the valve member 38, the valve body 40, the valve seal 42, and/or the valve seat 44 of valve assemblies 12 may be subjected to high pressures and cyclic impact loading. Such conditions may lead to, for example, premature valve failure through a combination of wear, leakage, and/or metal fatigue, resulting in the need for service and/or replacement. Applicant has recognized that secure engagement between the valve body 40 and the valve seal 42 may, in some instances, increase the service life of the valve assembly 12 and/or reduce required maintenance and downtime, for example, by reducing relative movement between the interface between the valve body 40 and the valve seal 42, for example, at the seal engaging surface 72 and the body engaging surface 76, which may, in turn, reduce or delay inelastic deformation of the valve seal 42 due to high cyclic loading.

For example, although the valve seal 42 may fit tightly around the valve body 40, cyclic compressive loading between the valve body 40 and the valve seal 42 interface may cause the valve seal 42 to effectively “shoulder out” against the seal engaging surface 72 of the valve body 40. In some embodiments, the engagement (e.g., a mechanical engagement) between the seal engaging surface 72 and the body engaging surface 76 of the valve seal 42 may resist and/or prevent such “shouldering out” of the valve seal 42 relative to the valve head 53.

In some embodiments, adhesives and/or fasteners may be used to more securely prevent relative movement between the valve body 40 and the valve seal 42. For example, adhesives, such as epoxies, resins, structural acrylic compounds, and/or another suitable adhering agent may be used. The use of adhesives and/or fasteners, however, may increase the complexity and expense of manufacturing the valve assemblies 12.

In addition, Applicant has recognized that exposure of some valve assemblies to extreme operating conditions, such as high-temperatures and/or corrosive and abrasive fluids, may degrade and/or prevent adhesives from successfully performing their intended function, for example, for extended periods of operation. Applicant has further recognized that under some operating conditions, at least some portions of the valve seal 42 may be displaced from the intended position relative to the valve body 42 (e.g., relative to the valve head 53 and/or the valve body 40), potentially resulting in misalignment of the seat engaging surface 78 of the valve seal 42 relative to the seat surface 50 of the valve seat 50. In addition, repeated “pancaking” of the valve seal 42 may cause the valve seal 42 to migrate or become displaced radially relative to the valve body axis X. This, in turn, may result in the valve seal 42 binding within the valve assembly 12, for example, at an oblique angle relative to the seat surface 50 of the valve seat 44, thereby providing a potential leak path and promoting premature wear of the valve seal 42. Additionally, when subjected to high cyclic loading and/or temperatures, valve seals may lose at least some of their elastic properties, preventing the ability of the valve seals to return to their designed configuration between opening and closing cycles.

In some embodiments, the engagement between the valve body 40 and the valve seal 42 may be substantially devoid of adhesives and/or fasteners, for example, relying primarily or solely on one or more of the physical geometries of the valve body 40 and/or the valve seal 42, for example, as described herein. For example, in some embodiments, the engagement between the seal engaging surface 72 of the valve body 40 and the body engaging surface 76 of the valve seal 42 may be substantially devoid of adhesives and/or fasteners, relying primarily or solely on one or more of the physical geometries of the valve body 40 and/or the valve seal 42, for example, as described herein. In some embodiments, this may result in a relatively less complex process and/or a relatively more efficient process for producing the valve assembly 12, for example, while substantially maintaining and/or improving the engagement between the valve body 40 and the valve seal 42. In some embodiments, adhesives and/or fasteners may be used supplement the engagement between the valve body 40 and the valve seal 42, for example, at the seal engaging surface 72 of the valve body 40 and the body engaging surface 76 of the valve seal 42.

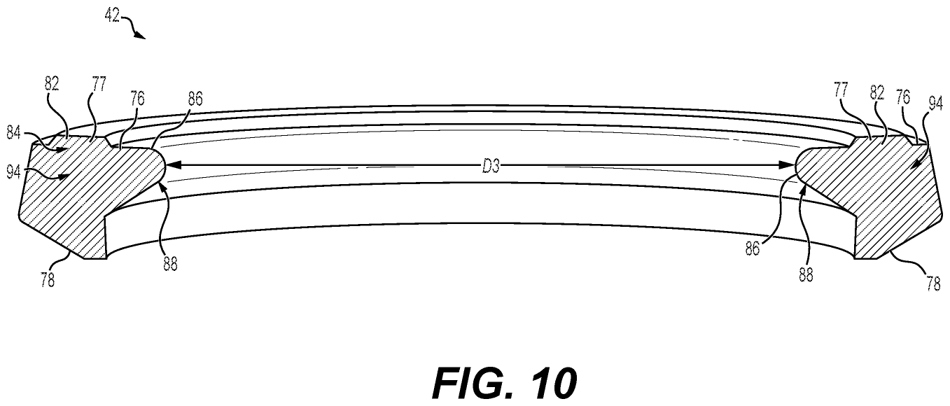

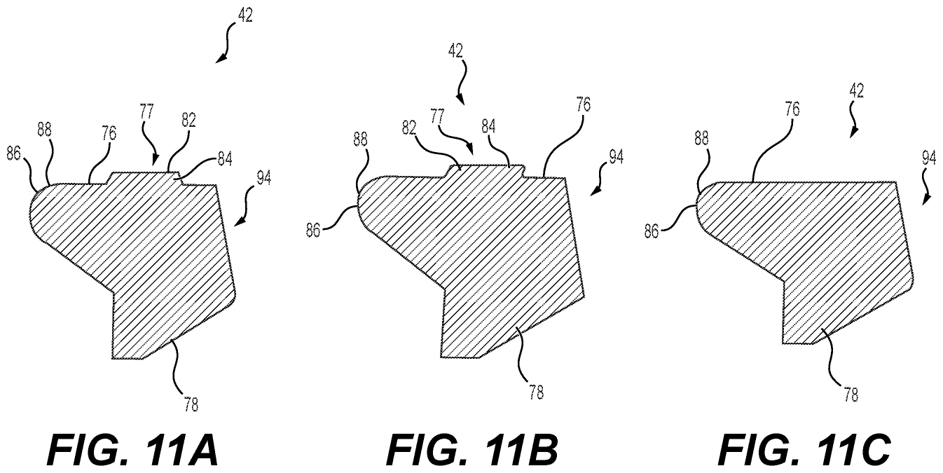

FIG. 10 is a schematic section view of an example valve seal 42, according to embodiments of the disclosure, and FIG. 11A, FIG. 11B, and FIG. 11C are partial section views of example valve seals 42 including respective example body engaging surfaces 76, according to embodiments of the disclosure. As shown in FIG. 10, some embodiments of the valve seal 42 may be substantially annular and may include an inner radial portion 86 at least partially defining a third radial dimension D3, for example, as described above. The valve seal 42 may define a seal cross-section 94, which may include the one or more cross-sections 84 of the one or more protrusions 82 of the body engaging surface 76 of the valve seal 42. As shown in FIGS. 11A and 11B, the one or more protrusions 82 may have a substantially polygonal-shaped cross-section 84 (see, e.g., FIG. 11A), which may be substantially trapezoidal-shaped (FIG. 11A), and/or may have a substantially parallelogram-shaped cross-section 84 (see, e.g., FIG. 11B). As shown in FIG. 11C, in some embodiments, the body engaging surface 76 of the valve seal 42 may be substantially planar, for example, as previously described herein. In at least some embodiments having a substantially planar body engaging surface 76, the body engaging surface 76 may be configured to deform and at least partially or completely fill one or more recesses 74 of the seal engaging surface of the valve body 40.

Although embodiments described herein include example valve bodies 40 having example seal engaging surfaces 72 including one or more recesses 74, and example valve seals 42 having example body engaging surfaces 76 including one or more example protrusions 82 and/or deformable material configured to deform and at least partially fill (e.g., completely fill) the one or more recesses 74, in some embodiments, the body engaging surface 76 of the valve seal 42 may include one or more recesses, and the seal engaging surface 72 of the valve body 40 may include one or more protrusions configured to engage the one or more recesses of the body engaging surface 76. In some embodiments, both the seal engaging surface 72 of the valve body 40 and the body engaging surface 76 of the valve seal 42 may include both recesses and protrusions, and the recesses and protrusions of each of the seal engaging surface 72 and the body engaging surface 76 may be configured to engage one another to create the engagement (e.g., a mechanical engagement) between the valve body 40 and the valve seal 42.

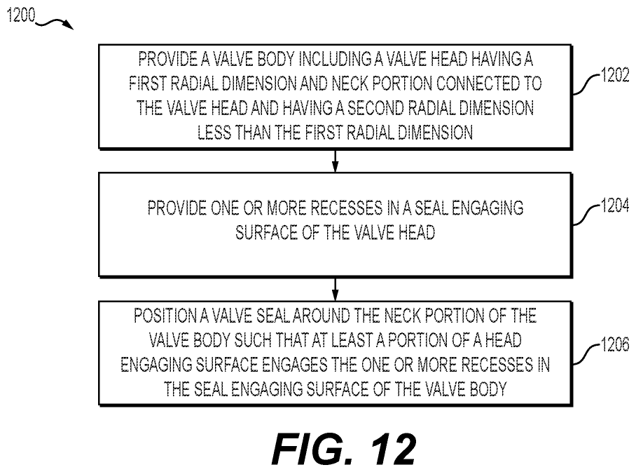

FIG. 12 is a block diagram of an example method 1200 for enhancing engagement between a valve seal and a valve body of a valve member for sealing fluid flow in a high-pressure pump, according to embodiments of the disclosure, such as any one or more of the example valve assemblies described herein, as well as others. The example method 1200 is illustrated as a collection of blocks in a logical flow graph, which represent a sequence of operations. In some embodiments of the example method 1200, one or more of the blocks may be manually and/or automatically executed. The order in which the operations are listed and described is not intended to be construed as a limitation, and any number of the described blocks may be combined in any order and/or in parallel to implement the method.

The example method 1200, at 1202, may include providing a valve body including a valve head having a first radial dimension and neck portion connected to the valve head and having a second radial dimension less than the first radial dimension, for example, as described herein.

At 1204, the example method 1200 may include providing one or more recesses in a seal engaging surface of the valve body, for example, as described herein.

At 1206, the example method 1200 may include positioning a valve seal around the neck portion of the valve body. For example, the valve seal may include a body engaging surface, and positioning the valve seal may include positioning the valve seal, such that at least a portion of the body engaging surface engages the one or more recesses in the seal engaging surface of the valve body and forms an engagement between the valve seal and the valve body, for example, as described herein. In some embodiments, the engagement may serve to resist, during operation of the of a high-pressure pump assembly in which the valve assembly has been placed, one or more of: (a) outward radial migration of the valve seal relative to the seal engaging surface of the valve body, (b) axial displacement of the valve seal relative to the seal engaging surface of the valve body, or (c) rotational displacement of the valve seal relative to the seal engaging surface of the valve body. In some embodiments, the valve seal may be substantially annular and may at least partially define a third radial dimension that, prior to connection to the valve body, is less than the second radial dimension of the neck portion of the valve body, and positioning the valve seal around the neck portion of the valve body may include stretching the valve seal radially to fit around the neck portion of the valve body. For example, a die, bearing press, and/or other suitable device may be used to push the valve seal axially into position relative to the valve body. In some embodiments, positioning the valve seal such that at least a portion of the body engaging surface engages the one or more recesses does not include application of adhesive.

In some embodiments of the method 1200, positioning the valve seal such that at least a portion of the body engaging surface engages the one or more recesses in the seal engaging surface of the valve body and forms an engagement between the valve seal and the valve body, may include engaging a substantially annular protrusion extending from the body engaging surface of the valve seal with the one or more recesses of the seal engaging surface of the valve body, for example, as described herein. The one or more recesses may include one or more substantially annular recesses having one or more of a substantially polygonal-shaped cross-section, a substantially trapezoidal-shaped cross-section, a substantially parallelogram-shaped cross-section, or a substantially serrated cross-section, for example, as described herein.

In some embodiments of the example method 1200, positioning the valve seal such that at least a portion of the body engaging surface engages the one or more recesses in the seal engaging surface of the valve body, may include providing the seal engaging surface with one or more protrusions having a cross-sectional shape substantially complimentary to the one or more substantially annular recesses. In some embodiments of the example method 1200, positioning the valve seal such that at least a portion of the body engaging surface engages the one or more recesses in the seal engaging surface of the valve body, may include causing material of the body engaging surface of the valve seal to deform and at least partially conform to the one or more recesses and form the engagement between the valve seal and the valve body, for example, as described herein. For example, causing material of the body engaging surface of the valve seal to deform and at least partially conform to the one or more recesses and form the engagement between the valve seal and the valve body may include compressing the valve seal against the seal engaging surface of the valve body, for example, during operation of the valve assembly.

In some embodiments, the method 1200 may include positioning a valve seat opposing the valve seal and substantially concentric with the valve body axis. The valve seat may at least partially define an opening and a substantially annular interior surface configured to receive and nest with the valve seal, for example, as described herein. When the valve assembly is closed during operation, sealing of the valve seat and valve seal may limit and/or prevent the flow of fluid through the opening, for example, as described herein.

In some embodiments, the example method 1200 may include providing an adhesive and/or fasteners to connect the valve body and the valve seal to one another, for example, to supplement engagement between the valve body and the valve seal, as described herein. Adhesive may be applied and/or cured between the seal engaging surface of the valve body and the body engaging surface of the valve seal.

Having now described some illustrative embodiments of the disclosure, it should be apparent to those skilled in the art that the foregoing is merely illustrative and not limiting, having been presented by way of example only. Numerous modifications and other embodiments are within the scope of one of ordinary skill in the art and are contemplated as falling within the scope of the disclosure. In particular, although many of the examples presented herein involve specific combinations of method acts or system elements, it should be understood that those acts and those elements may be combined in other ways to accomplish the same objectives. Those skilled in the art should appreciate that the parameters and configurations described herein are exemplary and that actual parameters and/or configurations will depend on the specific application in which the systems, methods, and/or aspects or techniques of the disclosure are used. Those skilled in the art should also recognize or be able to ascertain, using no more than routine experimentation, equivalents to the specific embodiments of the disclosure. It is, therefore, to be understood that the embodiments described herein are presented by way of example only and that, within the scope of any appended claims and equivalents thereto, the disclosure may be practiced other than as specifically described.

This application claims priority to, and the benefit of U.S. Provisional Application No. 63/387,825, filed Dec. 16, 2022, titled “SYSTEMS, ASSEMBLIES, APPARATUSES, AND METHODS PROVIDING ENHANCED ENGAGEMENT BETWEEN VALVE BODIES AND VALVE SEALS,” the disclosure of which is incorporated herein by reference in its entirety.

Furthermore, the scope of the present disclosure shall be construed to cover various modifications, combinations, additions, alterations, etc., above and to the above-described embodiments, which shall be considered to be within the scope of this disclosure. Accordingly, various features and characteristics as discussed herein may be selectively interchanged and applied to other illustrated and non-illustrated embodiment, and numerous variations, modifications, and additions further may be made thereto without departing from the spirit and scope of the present disclosure as set forth in the appended claims.

What is claimed is:

1. A valve member to enhance sealing of a fluid flow in a high-pressure pump assembly, the valve member comprising:
a valve body having a valve body axis, a valve head including a first radial dimension and extending in a direction transverse to the valve body axis, and a neck portion connected to the valve head and including a second radial dimension less than the first radial dimension, one or more of the valve head or the neck portion including a seal engaging surface at least partially defining one or more recesses; and
a valve seal connected to the valve body along the neck portion and adjacent the seal engaging surface of the valve body, the valve seal having a body engaging surface including one or more protrusions positioned so as to abut the seal engaging surface and received in the one or more recesses, thereby to provide an engagement between the valve seal and the valve body, such that during operation of the high-pressure pump assembly the engagement resists one or more of: (a) outward radial migration of the valve seal relative to the seal engaging surface of the valve body, (b) axial displacement of the valve seal relative to the seal engaging surface of the valve body, or (c) rotational displacement of the valve seal relative to the seal engaging surface of the valve body.

2. The valve member of claim 1, wherein the valve seal further comprises an inner radial portion adjacent the neck portion of the valve body, the inner radial portion having a curved cross-sectional profile.

3. The valve member of claim 1, wherein the valve body further comprises a stem extending from the neck portion and one or more legs extending axially from the stem, and wherein the one or more legs is axisymmetric about the valve body axis.

4. The valve member of claim 1, wherein the valve seal further comprises a substantially annular protrusion extending from the body engaging surface and configured to engage with the one or more recesses of the seal engaging surface of the valve body.

5. The valve member of claim 1, wherein the body engaging surface of the valve seal comprises material configured to deform and at least partially conform to the one or more recesses, thereby to provide the one or more protrusions and the engagement between the valve seal and the valve body.

6. The valve member of claim 1, wherein one or more of:
(a) the one or more recesses comprise a substantially annular recess having a substantially polygonal-shaped cross-section, and the seal engaging surface comprises one or more protrusions having a cross-sectional shape substantially complimentary to the substantially polygonal-shaped cross-section of the substantially annular recess,
(b) the one or more recesses comprise a substantially annular recess having a substantially trapezoidal-shaped cross-section, and the seal engaging surface comprises one or more protrusions having a cross-sectional shape substantially complimentary to the substantially trapezoidal-shaped cross-section of the substantially annular recess,
(c) the one or more recesses comprise a substantially annular recess having a substantially parallelogram-shaped cross section, and the seal engaging surface comprises one or more protrusions having a cross-sectional shape substantially complimentary to the substantially parallelogram-shaped cross-section of the substantially annular recess,
(d) the one or more recesses comprise one or more substantially annular recesses forming a substantially serrated cross-section, and the seal engaging surface comprises one or more protrusions having a cross-sectional shape substantially complimentary to the substantially serrated cross-section of the one or more substantially annular recesses,
(e) the body engaging surface of the valve seal comprises a substantially annular protrusion having a cross-sectional shape configured to nest within the one or more recesses of the seal engaging surface of the valve body, or
(f) the valve seal comprises a shoulder configured to be received adjacent the valve head and the neck portion of the valve body, the shoulder at least partially defining a third radial dimension that, prior to connection to the valve body, is less than the second radial dimension of the neck portion of the valve body.

7. The valve member of claim 1, wherein one or more of:
(a) the valve head is located at a proximal end of the valve body and comprises a valve head surface facing in a direction away from the seal engaging surface of the valve body, the seal engaging surface at least partially defining an annular surface opposite the valve head surface, and the valve head surface at least partially defining a spring recess positioned to receive a valve spring, or
(b) the valve head is located at a proximal end of the valve body and comprises a valve head surface facing in a direction away from the seal engaging surface of the valve body, the seal engaging surface at least partially defining an annular surface opposite the valve head surface, and the seal engaging surface positioned substantially perpendicular to the valve body axis.

8. The valve member of claim 1, wherein the valve seal further comprises a seat engaging surface opposite the body engaging surface and positioned to abut a valve seat, thereby to prevent fluid flow through the valve member, and wherein the seat engaging surface is substantially annular and extends in a direction oblique with respect to the valve body axis.

9. The valve member of claim 1, wherein the valve body further comprises:
a stem extending from the neck portion opposite the valve head, and
one or more legs extending axially from the stem, the stem and the neck portion at least partially defining a substantially annular flow channel through which fluid flows when the valve body is in an open position, and
wherein the stem at least partially defines a third radial dimension less than the second radial dimension of the neck portion of the valve body.

10. The valve member of claim 1, wherein the valve seal comprises an elastomeric material.

11. A valve assembly to enhance sealing of a fluid flow in a high-pressure pump assembly, the valve assembly comprising:
a valve member positioned to move between an open position to allow fluid flow through the valve assembly and a closed position to prevent fluid flow through the valve assembly, the valve member including:
a valve body having a valve body axis, a valve head including a first radial dimension and extending in a direction transverse to the valve body axis, and a neck portion connected to the valve head and including a second radial dimension less than the first radial dimension, one or more of the valve head or the neck portion having a seal engaging surface at least partially defining one or more recesses, and
a valve seal connected to the valve body along the neck portion and adjacent the seal engaging surface, the valve seal including:
a body engaging surface having one or more protrusions positioned to abut the seal engaging surface and received in the one or more recesses, thereby to provide an engagement between the valve seal and the valve body, such that during operation of the high-pressure pump assembly the engagement resists one or more of: (a) outward radial migration of the valve seal relative to the seal engaging surface of the valve body, (b) axial displacement of the valve seal relative to the seal engaging surface of the valve body, or (c) rotational displacement of the valve seal relative to the seal engaging surface of the valve body; and
a seat engaging surface, and
a valve seat including (i) a substantially cylindrical body having an opening therethrough and (ii) a seat surface, the seat surface positioned to abut the seat engaging surface of the valve seal, thereby to prevent fluid flow through the valve assembly.

12. The valve assembly of claim 11, wherein the valve seal further comprises a seat engaging surface positioned opposite the body engaging surface and positioned to abut the seat surface of the valve seat, thereby to prevent fluid flow through the valve assembly, the seat engaging surface of the valve seal and the seat surface of the valve seat configured to prevent fluid flow through the opening in the valve seat.

13. The valve assembly of claim 11, wherein;
the seat engaging surface is substantially annular and extends in a direction oblique with respect to the valve body axis, and
the seat surface of the valve seat is substantially annular and extends in a direction substantially parallel to the seat engaging surface.

14. The valve assembly of claim 11, wherein the valve seal further comprises an inner radial portion adjacent the neck portion of the valve body, the inner radial portion having a curved cross-sectional profile.

15. The valve assembly of claim 11, wherein the valve seal further comprises a substantially annular protrusion extending from the body engaging surface, the substantially annular protrusion configured to engage with the one or more recesses of the seal engaging surface of the valve body.

16. The valve assembly of claim 11, wherein the body engaging surface of the valve seal comprises material configured to deform and at least partially conform to the one or more recesses, thereby to form the one or more protrusions and provide the engagement between the valve seal and the valve body.

17. The valve assembly of claim 11, wherein one or more of:
(a) the one or more recesses comprises a substantially annular recess having a substantially polygonal-shaped cross-section, and the seal engaging surface comprises one or more protrusions having a cross-sectional shape substantially complimentary to the substantially polygonal-shaped cross-section of the substantially annular recess,
(b) the one or more recesses comprises a substantially annular recess having a substantially trapezoidal-shaped cross-section, and the seal engaging surface comprises one or more protrusions having a cross-sectional shape substantially complimentary to the substantially trapezoidal-shaped cross-section of the substantially annular recess,
(c) the one or more recesses comprises a substantially annular recess having a substantially parallelogram-shaped cross section, and the seal engaging surface comprises one or more protrusions having a cross-sectional shape substantially complimentary to the substantially parallelogram-shaped cross-section of the substantially annular recess,
(d) the one or more recesses comprises one or more substantially annular recesses forming a substantially serrated cross-section, and the seal engaging surface comprises one or more protrusions having a cross-sectional shape substantially complimentary to the substantially serrated cross-section of the one or more substantially annular recesses,
(e) the body engaging surface of the valve seal comprises a substantially annular protrusion having a cross-sectional shape configured to nest within the one or more recesses of the seal engaging surface of the valve body, or
(f) the valve seal comprises a shoulder configured to be received adjacent the valve head and the neck portion of the valve body, the shoulder at least partially defining a third radial dimension that, prior to connection to the valve body, is less than the second radial dimension of the neck portion of the valve body.

18. The valve assembly of claim 11, wherein one or more of:
the valve head is located at a proximal end of the valve body and comprises a valve head surface facing in a direction away from the seal engaging surface of the valve body, the seal engaging surface at least partially defining an annular surface opposite the valve head surface,
the valve head surface at least partially defines a spring recess, and the valve assembly further comprises a valve spring having an end positioned to abut the spring recess and bias the valve member against the valve seat, such that the seat engaging surface of the valve seal is compressed against seat surface of the valve seat, and
the seal engaging surface is substantially perpendicular to the valve body axis.

19. The valve assembly of claim 11, wherein:
the valve seal further comprises a seat engaging surface opposite the body engaging surface and positioned to abut a valve seat, thereby to prevent fluid flow through a valve assembly comprising the valve member, and
the seat engaging surface is substantially annular and extends in a direction oblique with respect to the valve body axis.

20. The valve assembly of claim 11, wherein the valve assembly comprises a one-way valve.

21. A fluid end assembly for a high-pressure reciprocating pump, the fluid end assembly comprising:
a manifold block at least partially defining a pump chamber and a manifold passage positioned to provide fluid communication with the pump chamber;
a valve assembly received in the manifold passage of the manifold block and positioned to control fluid flow through the manifold passage, the valve assembly having:
a valve member positioned to move between an open position allowing fluid flow through the valve assembly and a closed position preventing fluid flow through the valve assembly, the valve member including:
a valve body having a valve body axis, a valve head including a first radial dimension and extending in a direction transverse to the valve body axis, and a neck portion connected to the valve head and including a second radial dimension less than the first radial dimension, one or more of the valve head or the neck portion having a seal engaging surface at least partially defining one or more recesses, and
a valve seal connected to the valve body along the neck portion and adjacent the seal engaging surface, the valve seal including:
a body engaging surface including one or more protrusions positioned against the seal engaging surface and received in the one or more recesses, thereby to provide an engagement between the valve seal and the valve body, such that during operation of the high-pressure pump assembly the engagement resists one or more of: (a) outward radial migration of the valve seal relative to the seal engaging surface of the valve body, (b) axial displacement of the valve seal relative to the seal engaging surface of the valve body, or (c) rotational displacement of the valve seal relative to the seal engaging surface of the valve body, and
a seat engaging surface, and
a valve seat including (i) a substantially cylindrical body having an opening therethrough and (ii) a seat surface positioned to abut the seat engaging surface of the valve seal, thereby to prevent fluid flow through the valve assembly.

22. The fluid end assembly of claim 21, wherein one or more of:
(a) the valve seal further comprises a substantially annular protrusion extending from the body engaging surface, the substantially annular protrusion configured to engage with the one or more recesses of the seal engaging surface of the valve body,
(b) the body engaging surface of the valve seal comprises material configured to deform and at least partially conform to the one or more recesses, thereby to form the one or more protrusions and provide the engagement between the valve seal and the valve body,
(c) the one or more recesses comprises a substantially annular recess having a substantially polygonal-shaped cross-section, and the body engaging surface comprises one or more protrusions having a cross-sectional shape substantially complimentary to the substantially polygonal-shaped cross-section of the substantially annular recess,
(d) the one or more recesses comprises a substantially annular recess having a substantially trapezoidal-shaped cross-section, and the body engaging surface comprises one or more protrusions having a cross-sectional shape substantially complimentary to the substantially trapezoidal-shaped cross-section of the substantially annular recess,
(e) the one or more recesses comprises a substantially annular recess having a substantially parallelogram-shaped cross section, and the body engaging surface comprises one or more protrusions having a cross-sectional shape substantially complimentary to the substantially parallelogram-shaped cross-section of the substantially annular recess,
(f) the one or more recesses comprises one or more substantially annular recesses forming a substantially serrated cross-section, and the body engaging surface comprises one or more protrusions having a cross-sectional shape substantially complimentary to the substantially serrated cross-section of the one or more substantially annular recesses,
(g) the body engaging surface of the valve seal comprises a substantially annular protrusion having a cross-sectional shape configured to nest within the one or more recesses of the seal engaging surface of the valve body,
(h) the valve seal comprises a shoulder configured to be received adjacent the valve head and the neck portion of the valve body, the shoulder at least partially defining a third radial dimension that, prior to connection to the valve body, is less than the second radial dimension of the neck portion of the valve body, or
(i) the valve head is located at a proximal end of the valve body and comprises a valve head surface facing in a direction away from the seal engaging surface of the valve body, the seal engaging surface at least partially defining an annular surface opposite the valve head surface.

23. The fluid end assembly of claim 21, wherein the valve assembly comprises a one-way valve.

24. The fluid end assembly of claim 21, wherein:
the manifold passage comprises a first manifold passage,
the valve assembly comprises a first valve assembly, and
the fluid end assembly further comprises:
a second manifold passage in the manifold block positioned to provide fluid communication with the pump chamber, and
a second valve assembly received in the second manifold passage of the manifold block and positioned control fluid flow through the second manifold passage.

25. The fluid end assembly of claim 24, wherein:
the first valve assembly is positioned to allow fluid flow into the manifold chamber when the valve member of the first valve assembly is in an open position, and
the second valve assembly is positioned to allow fluid flow out of the manifold chamber when a valve member of the second valve assembly is in an open position.

26. A method for enhancing engagement between a valve seal and a valve body of a valve member to seal fluid flow in a high-pressure pump, the method comprising:
providing a valve body having a valve body axis, a valve head, the valve head including a first radial dimension and extending in a direction transverse to the valve body axis, and a neck portion connected to the valve head and including a second radial dimension less than the first radial dimension;
providing one or more recesses in a seal engaging surface of one or more of the valve head or the neck portion; and
positioning a valve seal along the neck portion of the valve body, the valve seal having a body engaging surface and configured such that one or more protrusions of the body engaging surface engage the one or more recesses in the seal engaging surface of the valve body and provide an engagement between the valve seal and the valve body, such that during operation of the high-pressure pump the engagement resists one or more of: (a) outward radial migration of the valve seal relative to the seal engaging surface of the valve body, (b) axial displacement of the valve seal relative to the seal engaging surface of the valve body, or (c) rotational displacement of the valve seal relative to the seal engaging surface of the valve body.

27. The method of claim 26, wherein positioning the valve seal along the neck portion of the valve body occurs absent application of adhesive to the valve body or the valve seal.

28. The method of claim 26, wherein one or more of:
(a) the valve seal is substantially annular and has a third radial dimension that, prior to connection to the valve body, is less than the second radial dimension of the neck portion of the valve body, and positioning the valve seal along the neck portion of the valve body includes stretching the valve seal radially so as to surround the neck portion of the valve body,
(b) positioning the valve seal along the neck portion of the valve body includes engaging a substantially annular protrusion extending from the body engaging surface of the valve seal with the one or more recesses of the seal engaging surface of the valve body, or
(c) the providing one or more recesses in a seal engaging surface of the valve body includes providing one or more substantially annular recesses having one or more of a substantially polygonal-shaped cross-section, a substantially trapezoidal-shaped cross-section, a substantially parallelogram-shaped cross-section, or a substantially serrated cross-section.

29. The method of claim 26, wherein:
the providing one or more recesses in a seal engaging surface of the valve body includes providing one or more substantially annular recesses having one or more of a substantially polygonal-shaped cross-section, a substantially trapezoidal-shaped cross-section, a substantially parallelogram-shaped cross-section, or a substantially serrated cross-section, and the positioning the valve seal along the neck portion of the valve body includes providing the seal engaging surface with one or more protrusions having a cross-sectional shape substantially complimentary to the one or more substantially annular recesses.

30. The method of claim 26, wherein one or more of:
(a) the positioning the valve seal along the neck portion of the valve body includes engaging a substantially annular protrusion extending from the body engaging surface of the valve seal with the one or more recesses of the seal engaging surface of the valve body
(b) positioning the valve seal along the neck portion of the valve body includes causing material of the body engaging surface of the valve seal to deform and at least partially conform to the one or more recesses and provide the engagement between the valve seal and the valve body, or
(c) causing material of the body engaging surface of the valve seal to deform and at least partially conform to the one or more recesses and provide the engagement between the valve seal and the valve body includes compressing the valve seal against the seal engaging surface of the valve body.
